(19) United States
(12) Patent Application Publication
(10) Pub. No.: US 2025/0073812 A1
(43) Pub. Date: Mar. 6, 2025

(54) APPARATUS FOR COLLECTING FUMES

(71) Applicant: Samuel Palmeter, Caro, MI (US)

(72) Inventor: Samuel Palmeter, Caro, MI (US)

(21) Appl. No.: 18/461,489

(22) Filed: Sep. 5, 2023

(51) Int. Cl. B23K 26/12; B08B 15/02

(52) U.S. Cl. CPC B23K 26/127; B08B 15/023; B23K 26/362

(57) ABSTRACT

A fume booster device connected to a laser marking apparatus to collect fumes accumulated in the apparatus while the apparatus is in its operational mode. The fume booster device includes a body, a front wall, a rear wall, a bottom wall, a top wall, and side walls. Am exhaust port is connected to and extends from the bottom wall. The exhaust port of a fanbuster is used to remove fumes inside the apparatus to the outside. The side wall includes a control port used to control on and off modes and the speed of the device. The front wall includes an open surrounded by a gasket to seal around the flange. A plurality of magnets are used to hold the device to the apparatus.

### DETAILED DESCRIPTION OF THE INVENTION

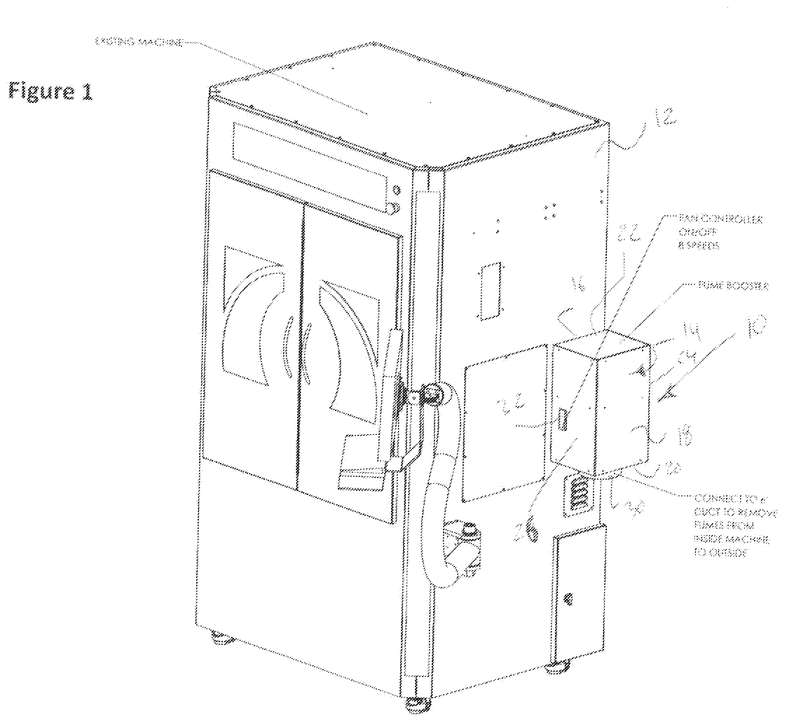

Referring to the FIGS. 1 through 3, an apparatus for collecting fume, i.e. a fume booster device, is shown at 10. Alluding to the above, for purposes of this patent document, the terms “or” and “and” Alluding to the above, for purposes of this patent document, the terms “or” and “and” shall mean “and/or” unless stated otherwise or clearly intended otherwise by the context of their use. The term “a” shall mean “one or more” unless stated otherwise or where the use of “one or more” is clearly inappropriate. The terms “comprise,” “comprising,” “include,” and “including” are interchangeable and not intended to be limiting. For example, the term “including” shall be interpreted to mean “including, but not limited to.”

Because explicit identification of object-oriented constructs expressed through the syntax of high-level object-oriented programming languages is lost during compilation to binary code (e.g., translation of a source code definition or representation of an application to a binary code definition or representation of the application such as a machine code or byte-code definition), potential security vulnerabilities can be obscured during static analysis of the resulting binary code. For example, because information about an object (e.g., the class on which the object is based, the size of the object, the number and types or sizes of properties of the object, and the number of functionalities accessible to the object via a dispatch table) is typically not expressed in binary code, determining whether indirect operations relative to the object expose security vulnerabilities can be difficult without the source code from which the binary code was generated.

As a specific example, an indirect operation can result in arbitrary code execution security vulnerabilities if the binary code does not include run-time validation to ensure that the indirect operation does not operate outside or beyond the object (i.e., at memory addresses not allocated to or shared by the object). Some binary code representations of applications, however, do include information about objects. Such information can be included in binary code as run-time type information (RTTI) or debugging information that is compiled into the binary code. Nevertheless, because the binary code representations of many applications do not include such information (e.g., to discourage reverse engineering of these applications), robust methodologies and systems for analyzing binary code based on (or derived from) source code using object-oriented techniques should not assume availability of such information.

Implementations discussed herein analyze operations described in binary code to identify objects based on those operations. Said differently, implementations discussed herein reconstruct, at least partially, objects (or representations of objects) by inferring the structure of such objects based on operations described in binary code. Furthermore, implementations discussed herein perform security vulnerability analyses of binary code representations of applications using such objects. For example, implementations discussed herein can identify security vulnerabilities such as type confusion vulnerabilities that can result in arbitrary code execution, code injection, application failure, or other undesirable or unintended behavior of an application using information about objects identified by analysis of operations described in binary code.

Accordingly, implementations discussed herein with reference to analysis of operations described in binary code should be understood to refer to analysis of those operations using a binary code representation of a software module or a representation of the software module derived from the binary code representation. A variable within a memory is a memory location at which one or more values can be stored. Such a memory location can be at a processor memory (e.g., a register or cache), at a system memory (e.g., a Random Access Memory (RAM) of a computing system), or at some other memory. Operations within binary code that operate on such variables can refer to a memory address (either absolute or relative to another memory address such as an offset from a stack pointer) of that memory location.

As used herein, the term “module” refers to a combination of hardware (e.g., a processor such as an integrated circuit or other circuitry) and software (e.g., machine- or processor-executable instructions, commands, or code such as firmware, programming, or object code).

A combination of hardware and software includes hardware only (i.e., a hardware element with no software elements), software hosted at hardware (e.g., software that is stored at a memory and executed or interpreted at a processor), or at hardware and software hosted at hardware. Additionally, as used herein, the singular forms “a,” “an,” and “the” include plural referents unless the context clearly dictates otherwise. Thus, for example, the term “module” is intended to mean one or more modules or a combination of modules. Furthermore, as used herein, the term “based on” includes based at least in part on. Thus, a feature that is described as based on some cause, can be based only on that cause, or based on that cause and on one or more other causes. It will be apparent that multiple embodiments of this disclosure may be practiced without some or all of these specific details. In other instances, well-known process operations have not been described in detail in order not to unnecessarily obscure the present embodiments.

The following description of embodiments includes references to the accompanying drawing. The drawing shows illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and operational changes can be made without departing from the scope of what is claimed. The following detailed description is, therefore, not to be taken in a limiting sense, and the scope is defined by the appended claims and their equivalents. Alluding to the above, for purposes of this patent document, the terms “or” and “and” shall mean “and/or” unless stated otherwise or clearly intended otherwise by the context of their use. The term “a” shall mean “one or more” unless stated otherwise or where the use of “one or more” is clearly inappropriate. The terms “comprise,” “comprising,” “include,” and “including” are interchangeable and not intended to be limiting. For example, the term “including” shall be interpreted to mean “including, but not limited to.”

FIG. 1 is a perspective view of a fume booster device connected to a laser marking apparatus;

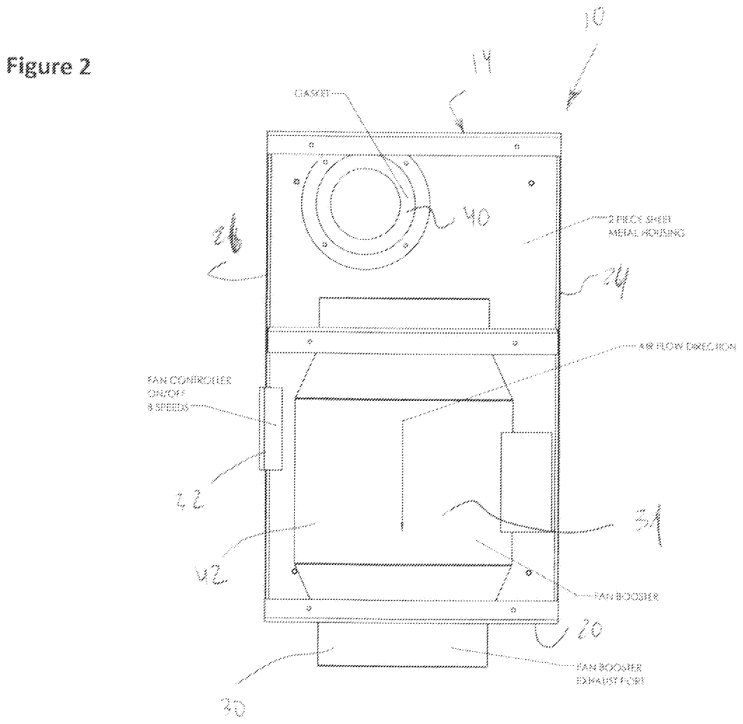

FIG. 2 is a cross sectional view of the fume booster device;

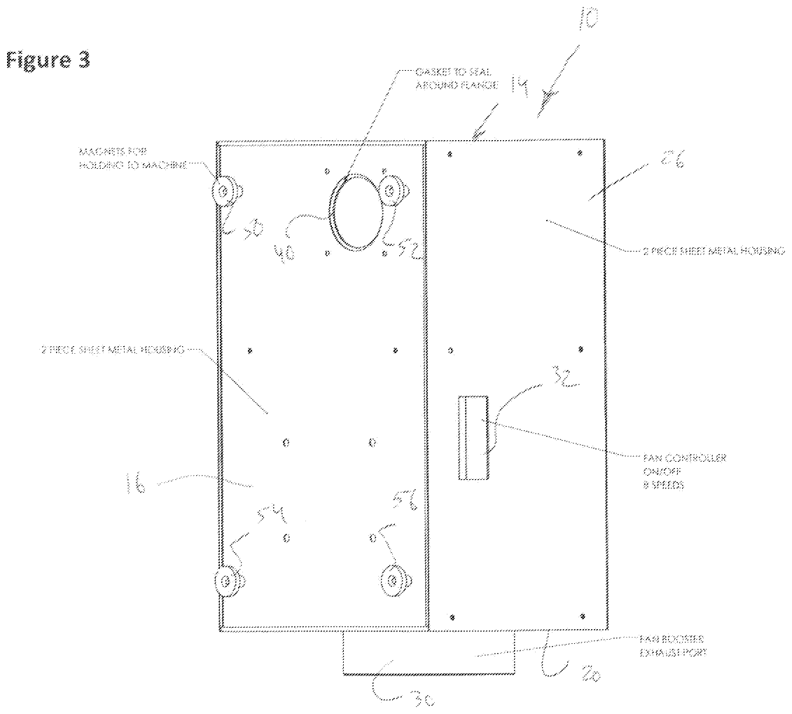

FIG. 3 is a perspective view of the fume booster device.

As set forth in FIG. 1, the fume booster device 10 connected to a laser marking apparatus 12 to collect fumes accumulated in the apparatus 12 while the apparatus 12 is in its operational mode. The fume booster device 10 includes a body, generally indicated at 14, a front wall 16, a rear wall 18, a bottom wall 20, a top wall 22, and side walls 24 and 26. Am exhaust port 30 is connected to and extends from the bottom wall 20. The exhaust port 30 of a fanbuster 31 is used to remove fumes inside the apparatus 12 to the outside. The side wall 26 includes a control port 32 used to control on and off modes and the speed of the device 10. The front wall 16 includes an open surrounded by a gasket 40 to seal around the flange. A plurality of magnets 50, 52, 54, and 56 are used to hold the device 10 to the apparatus 12. The fume booster device 10 includes a generally rectangular form and is formed from a metal. Those skilled in the art will appreciate that the shape, configuration, and material of the fume booster device 10 as shown herewith is not intended to limit the scope of the present invention.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A fume booster device connected to a laser marking apparatus to collect fumes accumulated in the laser marking apparatus while the apparatus is in its operational mode, said fume booster device comprising:
a body, a front wall, a rear wall, a bottom wall, a top wall, and side walls;
an exhaust port is connected to and extends from the bottom wall, said exhaust port of a fanbuster is used to remove fumes inside the apparatus to the outside;
a side wall includes a control port used to control on and off modes and the speed of said fume booster device;
said front wall includes an open surrounded by a gasket to seal around said flange; and
a plurality of magnets are used to hold said fume booster device to the apparatus.
